(19) United States
(12) Patent Application Publication
(10) Pub. No.: US 2020/0058013 A1
(43) Pub. Date: Feb. 20, 2020

(54) GEO-FILTERED PAYMENT PRODUCT

(71) Applicant: Maritz Holdings Inc., Fenton, MO (US)

(72) Inventors: Drew Carter, St. Louis, MO (US); Mark Barbee, Ballwin, MO (US); Brendan Sullivan, St. Louis, MO (US); Lisa Lewandowski, Ballwin, MO (US); Electi Dowd, Marthasville, MO (US)

(21) Appl. No.: 16/544,354

(22) Filed: Aug. 19, 2019

Related U.S. Application Data
(60) Provisional application No. 62/765,001, filed on Aug. 17, 2018.

(51) Int. Cl. G06Q 20/32; G06Q 20/20; H04W 4/021; G06Q 30/02

(52) U.S. Cl. CPC G06Q 20/3224; G06Q 20/204; G06Q 30/0238; H04W 4/021; G06Q 20/206

(57) ABSTRACT

Geo-filtered payment product for use in a rewards or incentive program. A program manager server defines a geo-fence and creates a payment product valid within the defined geo-fence. A payment processing server receives a transaction request from a merchant point-of-sale (POS) device to transact a purchase using the payment product on a participant computing device. The payment processing server determines if the participant computing device is located within the defined geo-fence based on the received transaction request, which includes location information, and sends an authorization message to the merchant POS device via the communication network for approving the transaction request when the participant computing device is determined to be located within the defined geo-fence.

### CROSS REFERENCE TO RELATED APPLICATION

This application claims the benefit of U.S. Provisional Patent Application No. 62/765,001, filed Aug. 17, 2018, the contents of which are incorporated by reference in their entirety for all purposes.

### BACKGROUND

Aspects of the present disclosure relate to systems and methods of payment in a geo-filtered transaction.

Incentive programs issue redeemable points or other benefits to customers as a reward for certain activities (e.g., displaying brand loyalty, purchasing certain products or services, or performing a certain action). These points create a loyalty or affinity with the customer and encourage the customer to continue a desired behavior. The incentive programs are offered by program owners, who determine the eligibility and redemption rules for the programs. Program managers manage the incentive programs on behalf of a program owner and reconciling the amounts due from and to the parties and/or entities to the redemption transaction. The points needed to obtain the reward (e.g., the ticket) are deducted from the customer's point account upon redemption.

Automated systems for the redemption of points for rewards typically provide interfaces for the interaction between entities necessary to fulfill the reward request. Such entities may include a program owner, a program manager, redemption vendors, and a broker that acts as an intermediary between a participant and the redemption vendors. The customer selects a reward for purchase with the points and indicates the number of points to use towards the purchase of the particular product or service that has been selected. Existing systems such as disclosed in U.S. Pat. No. 7,143,087, the entire disclosure of which is incorporated herein by reference, typically utilize a single, hidden, large-balance credit card account held by the program manager to pay the vendor for the selected item or service, where the program manager thereafter reconciles the transaction and bills the appropriate parties.

While there are numerous way to filter a payment product, such as by merchant or industry code, there is a need for filtering a payment product by specific geographic location for improved incentive programs.

### SUMMARY

In view of known problems associated with payment products for use in incentive and rewards programs, systems and methods that can filter such payment products based on geographic boundaries are desired.

In an aspect, a system includes a program manager server that executes processor-executable instructions to define a geo-fence and creates a payment product valid within the defined geo-fence. A payment processing server executes processor-executable instructions to receive a transaction request from a merchant point-of-sale (POS) device to transact a purchase using the payment product on a participant computing device. The payment processing server further determines if the participant computing device is located within the defined geo-fence based on the received transaction request, which includes location information, and sends an authorization message to the merchant POS device via the communication network for approving the transaction request when the participant computing device is determined to be located within the defined geo-fence.

In another aspect, a method includes defining a geo-fence, creating a payment product valid within the defined geo-fence, and sending the payment product to a participant computing device for use within the defined geo-fence to initiate a rewards program. Also, the method includes receiving at least one transaction request from a merchant POS device to transact a purchase using the payment product on the participant computing device and determining if the participant computing device is located within the defined geo-fence based on the received transaction request, which includes coordinate information corresponding to a location of the participant computing device. The method further includes sending an authorization message to the merchant POS device for approving the transaction request when the participant computing device is determined to be located within the defined geo-fence.

In yet another aspect, a system includes a program manager server that executes processor-executable instructions to define a geo-fence, create a payment product valid within the defined geo-fence, and send the payment product to a participant for use within the defined geo-fence. The system also includes a merchant point-of-sale (POS) device that executes processor-executable instructions to read account and location information from the payment product when presented to the merchant POS device to transact a purchase and generate a transaction request based on the account and location information and a monetary amount of the purchase. Further, the system includes a payment processing server that executes processor-executable instructions to receive the transaction request to transact the purchase using the payment product from the merchant POS device via the communication network, determine if the purchase is located within the defined geo-fence based on the received transaction request, and send an authorization message to the merchant POS device via the communication network for approving the transaction request when the purchase is determined to be located within the defined geo-fence.

Other objects and features will be in part apparent and in part pointed out hereinafter.

### BRIEF DESCRIPTION OF THE DRAWINGS

FIG. 1 is a functional block diagram of an example system including a geo-fenced location distributed area.

FIG. 2 is a functional block diagram illustrating an occurrence of a transaction and authorization process against a geo-filter, which may be deployed within the system of FIG. 1.

FIG. 3 is a functional block diagram of an example system including a geo-fenced location distributed area.

FIG. 4 is a series of exemplary screenshots illustrating user experience when accessing an app for promotional events, payment, and terms on a computing device that may be used in the system architecture of FIG. 1.

FIG. 5 is a flow diagram of an example payment flow from cardholder through network to merchant payment.

FIG. 6 is a flow diagram of an example transaction authorization process.

Corresponding reference characters indicate corresponding parts throughout the drawings.

### DETAILED DESCRIPTION

Aspects of the present disclosure relate to utilizing technology to filter a payment product, or vehicle, to a specific geographical location or area. This payment vehicle would be used to create virtual prepaid reward card products or other payment products that are compatible with the major mobile wallet providers. Payment is then usable in-store and at point-of-sale (POS) within the predefined or specified geographic area. As described below, a sponsoring client or other program initiator loads or allocates funds to the payment product and defines a geo-location or geo-fence before distributing the payment product to a consumer.

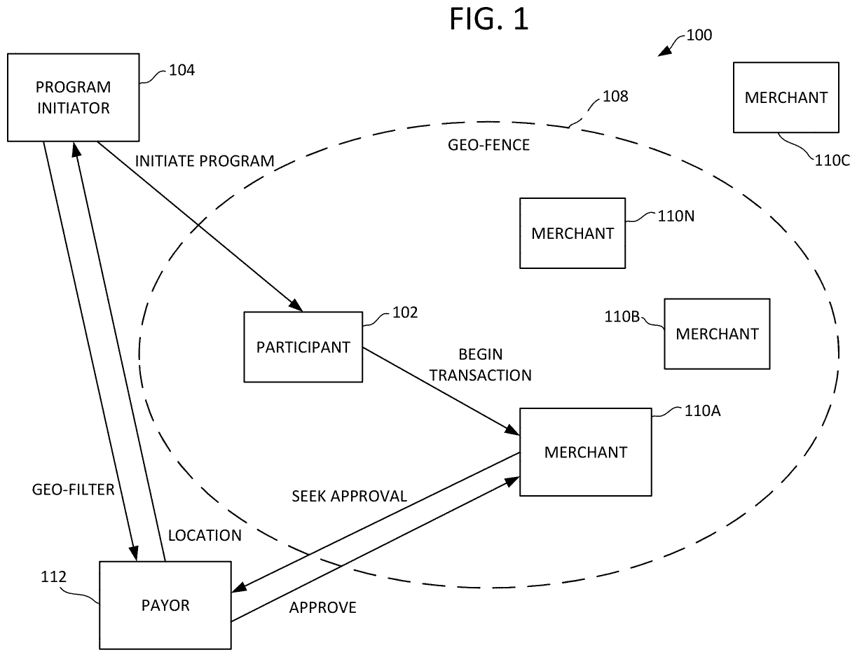

FIG. 1 illustrates a system 100 according to an embodiment of the present disclosure in block diagram form. A participant 102 is a member of a participant/customer points program, for instance, for providing incentives or rewards or for encouraging a certain response. Such programs include a frequency program, an appeasement program, a promotions program, and the like. As an example, the participant 102 may be a member of a loyalty program that includes individual participant accounts indicating the number of points that each participant has been awarded or earned by the loyalty program. For example, the loyalty program may award participants for purchases of goods from a particular vendor or group of vendors. For every dollar spent in purchasing and completing a transaction, the participant would be awarded points that are added to the participant's points account. Commonly assigned U.S. Pat. Nos. 7,134,087 and 8,831,976, the entire disclosures of which are incorporated herein by reference, disclose payment products as well as system architectures for use in connection with a rewards or loyalty program. Advantageously, aspects of the present disclosure permit limiting the transactions to a particular geographic area.

In an embodiment, a program manager server, referred to as program initiator 104, identifies at least one specific geographic location, illustrated as geo-fence 108, and then establishes a filter on the payment product so the card or mobile wallet can only be redeemed at locations within a certain set of geographic coordinates, i.e., within the geo-fence 108. Geo-location identifies the geographic location of an object digitally via information through the Internet or other communication networks. Geo-fencing is a type of geo-location that uses global positioning system (GPS), radio frequency identification (RFID), Wi-Fi, or cellular data or the like to define geographical boundaries and trigger actions when a device or tag enters or exits a specified virtual boundary. Geo-fencing allows an administrator to set up triggers so when a device enters (or exits) the boundaries defined by the administrator, an alert is issued.

It is to be understood that the virtual barrier of geo-fence 108 can be active or passive within the scope of the present disclosure. Active geo-fences, for instance, require an end user to opt-in to location services and a mobile app to be open on the user's smartphone. Passive geo-fences, on the other hand, are always on. They rely on Wi-Fi and/or cellular data instead of GPS or RFID so they can work in the background.

As shown in FIG. 1, the program initiator 104 initiates the program by providing participant 102 with a physical credit/debit card or a virtual payment product (e.g., a transfer to the participant's mobile wallet) for use in redeeming a reward. The participant 102 then attempts to redeem the reward by making a purchase at a merchant 110A. In the illustrated embodiment, a plurality of merchants 110A to 110N are available to participant 102 for transactions either inside or outside geo-fence 108.

To process the payment and seek approval for the transaction, a POS device of the merchant 110A provides payment product details via an Internet connection or telephone line to a payment processing server, referred to as payor 112. The payor 112, which generally represents the authorization process in the illustrated embodiment, is communicatively coupled to the merchants 110A-110N and to the program initiater 104 via a data communications network, such as the Internet. In an embodiment, payor 112, either stores data or retrieves data representative of the predefined geo-fence 108 to determine if participant 102 is either inside or outside geo-fence 108. Although not illustrated, it is to be understood that payor 112 can include an acquiring bank or its acquiring processor, a credit card network, and/or an issuing bank. In a typical credit card transaction, the merchant sends the payment product details to the acquiring bank or processor, when then forwards the information to a credit card network. The credit card network clears the payment and requests payment authorization from the issuing bank. According to an embodiment of the present disclosure, payor 112 processes the transaction based on not only the payment amount but also the location of participant 102 within geo-fence 108. The payor 112 determines that participant 102 is within geo-fence 108 by, for instance, location information associated with merchant 110A or by global positioning system (GPS) tracking of participant 102.

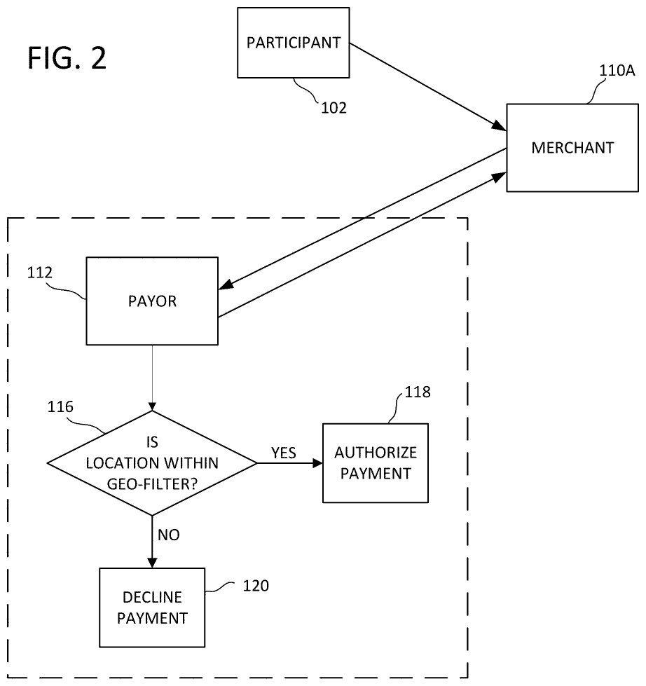

FIG. 2 illustrates an example approval process. As shown, payor 112 determines at 116 if participant 102 is attempting the transaction with merchant 110A within geo-fence 108. If so, payor 112 approves the transaction at 118. If not, payor 112 declines the transaction at 120.

The process for determining whether participant 102 is located within geo-fence 108 involves application of a geo-location filter by payor 112. In one embodiment, this filter preferably incorporates GPS, radio frequency identification (RFID), near field communication (NFC), Bluetooth, Wi-Fi, and/or geomagnetic technologies, or the like, to define and create a virtual boundary. Commonly assigned U.S. Pat. No. 10,311,267, the entire disclosure of which is incorporated herein by reference, discloses beacon tracking using wireless communications such as Bluetooth. The payment vehicle would be tokenized for use within a mobile wallet allowing participant 102 to utilize it as a form of payment at select retail locations within a certain set of geographic coordinates. A retail spend within geo-fence 108 would draw down from balance on the payment product. For instance, the location of the participant 102 is known by GPS tracking, such as is available on smartphones.

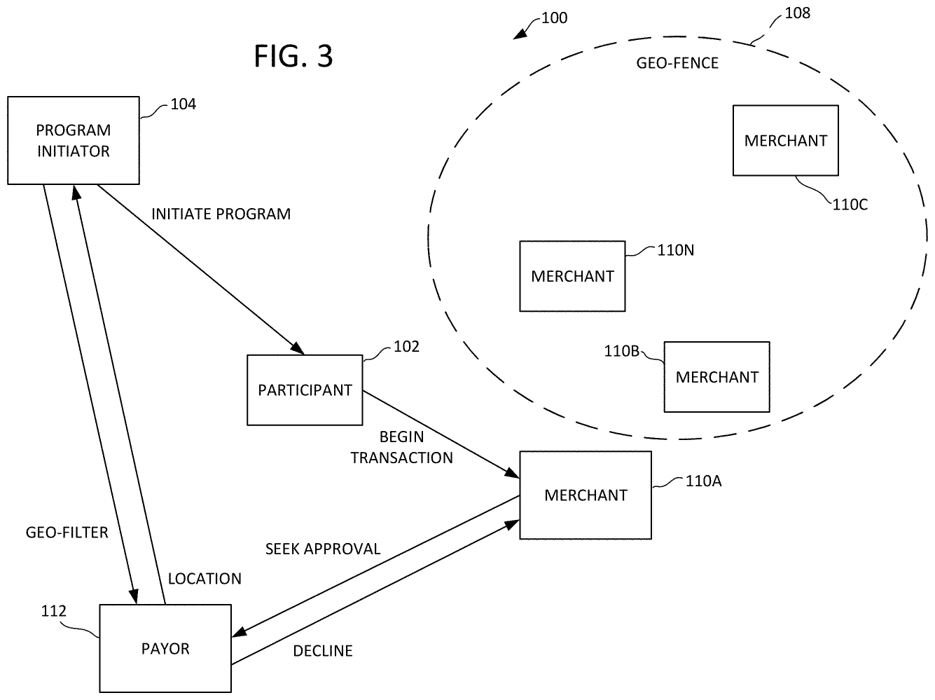

As shown in FIG. 3, merchant 110A is located outside geo-fence 108 such that payor 112 would decline the attempted transaction.

Filtering the payment product provides advantages over merely filtering by merchant or industry code or the like. Examples of new applications for products and solutions made available by filtering according to a specific geographic location include tourist, community, and shopping promotions, airline appeasement offers, and convention or conference perks.

According to one example, the geo-filtered payment product is especially well-suited for use in an airline appeasement offer. If an airline delays a flight for a lengthy period of time, it can appease the delayed passengers with a geo-filtered payment product. As an appeasement for the inconvenience, the airline can send the passengers a link to retrieve a geo-filtered payment product to their mobile wallets (e.g., “dinner on Southwest”) redeemable at merchant locations within the airport.

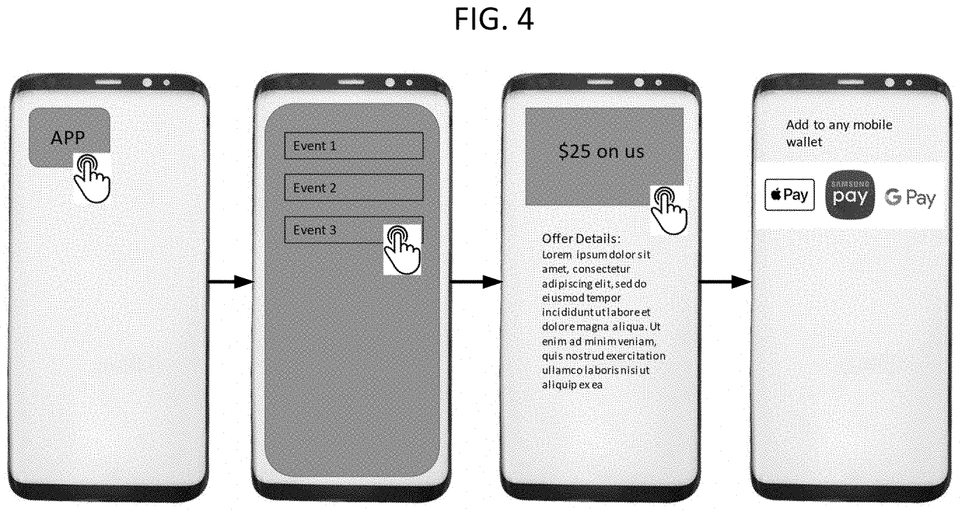

FIG. 4 is a series of exemplary screenshots illustrating user experience when accessing an app for promotional events, payment, and terms on a computing device such as a smartphone for retrieving a geo-filtered payment product to participate in the appeasement program or the like.

Another use example relates to a tourist board promotion designed to get people to visit a particular city. As part of the promotion, visitors receive a geo-filtered card for use at any retail location inside the city's geographic region. Similarly, the geo-fence could be drawn tighter and limited to a particular hotel, resort, theme park, or the like. For example, a resort hotel/resort town, such as Vail Village, can offer full or partial payments at recommended restaurants, ski rentals, etc. In this example, the merchants need not actively enroll or pay commissions because the geo-filtering would not be known to them. In another example, a hotel or resort may wish to seek commissions from the merchants because the geo-filtered payment product would incentivize participants to conduct transactions with selected merchants for geo-targeted activities. In yet another example, a travel agent or a theme park itself can offer a $50 geo-filtered card to those purchasing theme park tickets on a specific website for use in the theme park or even within a specific area of the theme park.

Similarly to a tourist promotion, a community promotion is another use example for geo-filtered payment products. For example, patients with lengthy stays in a hospital and their families often require food or clothing items as well as services such as laundry, yard mowing, house cleaning, etc. In this example, a hospital or insurance company can fund a geo-fenced tiered product from local merchants to improve the patient experience. A geo-filtered payment product can also promote community interests as a fund-raising mechanism for local schools, clubs, and other organizations. In yet another example, parents can provide a payment product to their children that geographically limits spending to on-campus merchants. Further to this example, the payment product could be tied to a college savings account thus ensure the funds are spent on education-related items.

In yet another example, a shopping promotion can encourage participants to shop at stores in a particular mall or shopping center by geo-targeting a payment product for limited use within the mall or shopping center.

Aspects of the present disclosure also pertain to a convention or conference perks program. For example, as an incentive to attend, convention participants are sent a preloaded, geo-filtered card to help cover their expenses while at the convention. In this example, the geo-filtered card is only redeemable within the geographic area of the convention.

In each of the above-noted examples, points can be used instead of currency without deviating from the scope of the invention.

This payment vehicle would be used to create virtual prepaid reward card products or other payment products that are compatible with the major mobile wallet providers. Payment is then usable in store and at point of sale.

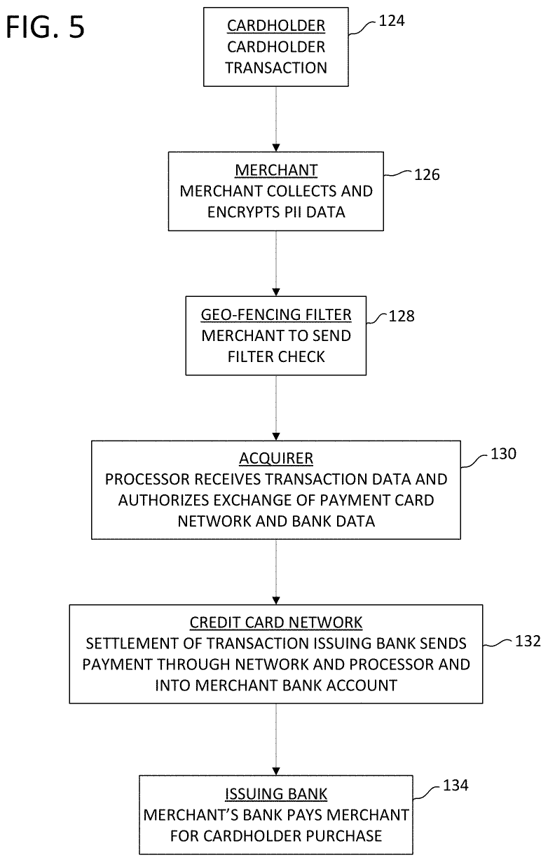

FIG. 5 is a flow diagram of an example payment flow from cardholder through network to merchant payment. Beginning at 124, participant 102 attempts to redeem the reward by making a purchase at merchant 110A. To process the payment and seek approval for the transaction, merchant 110A collects payment product details and encrypts the information at 126 for sending to payor 112 to check the geo-filter at 128. An acquiring processor receives the transaction data at 130 and authorizes the exchange of data between a credit card network and an issuing bank. Settlement of the transaction occurs at 132 as the issuing bank sends payment via the credit card network and acquiring processor to the merchant's bank for payment at 134.

FIG. 2 illustrates an example approval process. As shown, payor 112 determines at 116 if participant 102 is attempting the transaction with merchant 110A within geo-fence 108. If so, payor 112 approves the transaction at 118. If not, payor 112 declines the transaction at 120.

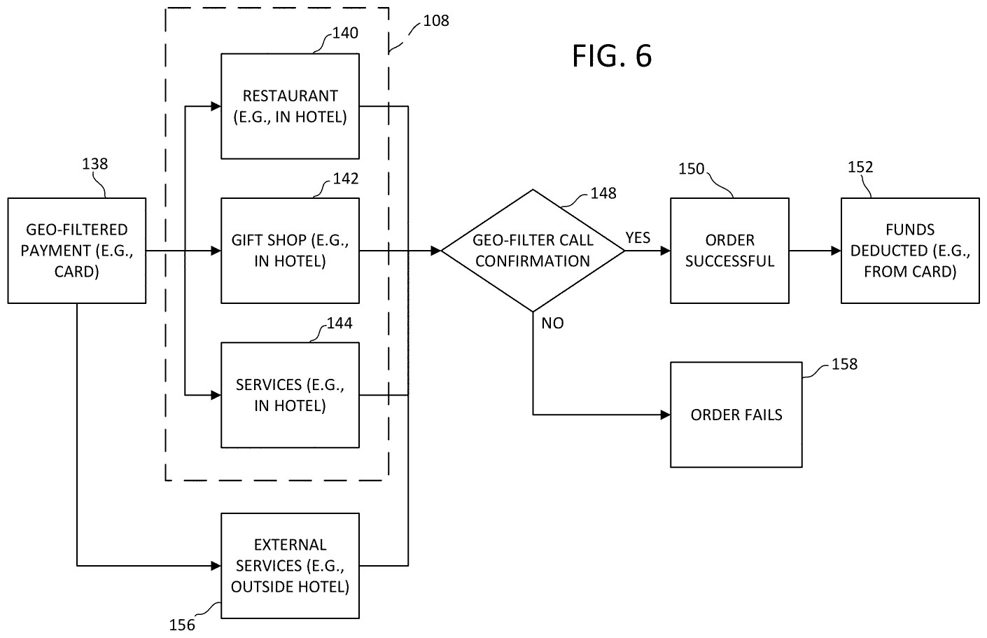

Referring further to the use examples described above, FIG. 6 is a flow diagram of an example transaction authorization process. As shown in FIG. 6, participant 102 uses a geo-filtered payment product 138, which can be a physical or virtual card for use a various merchants located geographically within, for example, a hotel. Such merchants include a restaurant 140, a gift shop 142, and on-site services 144 (e.g., hotel spa). As described above, payor 112 confirms the geo-filter at 148 and, if the merchant is within geo-fence 108, authorizes the transaction at 150 and deducts the funds from the card account at 152 for paying the merchant. On the other hand, if participant uses the geo-filtered card 138 at a merchant that is off-property, as indicated at 156, the geo-filter cannot be confirmed at 148 and payor 112 declines the transaction at 158.

While the above described steps are described using sequential ordering, it should be understood that some of the illustrative steps can be performed in parallel and/or simultaneously without departing from the scope of the present invention. FIG. 5 illustrates an exemplary embodiment of some, but not all, aspects of the claimed invention.

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the preferred methods and materials are described above.

Embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, solid state drives (SSDs), and the like.

The computer typically includes a variety of computer readable media. Computer readable media can be any available media that can be accessed by the computer and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media are non-transitory and include, but are not limited to, RAM, ROM, EEPROM, flash memory or other memory technology, CD-ROM, digital versatile disks (DVD) or other optical disk storage, SSDs, magnetic cassettes, magnetic tape, magnetic disk storage or other magnetic storage devices, or any other medium which can be used to store the desired non-transitory information, which can accessed by the computer. Alternatively, communication media typically embody computer readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as a video adapter. In addition to the monitor, personal computers typically include other peripheral output devices (not shown), such as speakers and printers.

One or more aspects of the disclosure may be embodied in computer-executable instructions (i.e., software), routines, or functions stored in system memory or non-volatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Embodiments of the disclosure may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a program manager server, the program manager server including a memory device storing instructions that, when executed by the program manager server, configure the program manager server to:
define a geo-fence,
create a payment product valid within the defined geo-fence, and
send the payment product to a participant computing device for use within the defined geo-fence; and
a payment processing server communicatively coupled to the program manager service via a communication network, the payment processing server including a memory device storing instructions that, when executed by the payment processing server, configure the payment processing server to:
receive at least one transaction request from a merchant point-of-sale (POS) device to transact a purchase using the payment product on the participant computing device,
determine if the participant computing device is located within the defined geo-fence based on the received transaction request, wherein the merchant POS device is communicatively coupled to the payment processing server via the communication network and the payment processing server receives the transaction request from the merchant POS device via the communication network, and wherein the transaction request includes coordinate information corresponding to a location of the participant computing device, and
send an authorization message to the merchant POS device via the communication network for approving the transaction request when the participant computing device is determined to be located within the defined geo-fence.

2. The system of claim 1, wherein the payment product comprises a virtual payment product stored in a mobile wallet application on a smartphone.

3. The system of claim 2, wherein the payment product includes a token for use within the mobile wallet application identifying the payment product for use within the defined geo-fence.

4. The system of claim 1, wherein the memory device of the payment processing server stores instructions that, when executed by the payment processing server, further configure the payment processing server to send a denial message to the merchant POS device via the communication network for declining the transaction request when the participant computing device is determined to be located outside the defined geo-fence.

5. The system of claim 1, further comprising the merchant POS device, the merchant POS device communicatively coupled to the payment processing server via the communication network, the merchant POS device including a memory device storing instructions that, when executed by the merchant POS device, configure the merchant POS device to:
read account and location information from the payment product, and
generate the transaction request based on the account and location information and a monetary amount of the purchase.

6. The system of claim 1, further comprising the merchant POS device, the merchant POS device communicatively coupled to the payment processing server via the communication network, and the merchant POS device including a memory device storing instructions that, when executed by the merchant POS device, configure the merchant POS device to encrypt the transaction request before sending the transaction request to the payment processing server.

7. The system of claim 1, wherein the memory device of the payment processing server stores instructions that, when executed by the payment processing server, further configure the payment processing server to extract the coordinate information from the transaction request and send the coordinate information to the program manager server via the communication network, wherein the memory device of the program manager server stores instructions that, when executed by the program manager server, further configured the program manager server to compare the coordinate information to the defined geo-fence.

8. The system of claim 1, wherein the program manager server defines the geo-fence based on at least one of the following technologies: global positioning system (GPS), radio frequency identification (RFID), near field communication (NFC), Bluetooth, Wi-Fi, and geomagnetic.

9. A method comprising:
defining a geo-fence;
creating a payment product valid within the defined geo-fence;
sending the payment product to a participant computing device for use within the defined geo-fence to initiate a rewards program;
receiving at least one transaction request from a merchant point-of-sale (POS) device to transact a purchase using the payment product on the participant computing device;
determining if the participant computing device is located within the defined geo-fence based on the received transaction request, wherein the transaction request includes coordinate information corresponding to a location of the participant computing device; and
sending an authorization message to the merchant POS device for approving the transaction request when the participant computing device is determined to be located within the defined geo-fence.

10. The method of claim 9, further comprising storing the payment product in a mobile wallet application on a smartphone as a virtual payment product.

11. The method of claim 10, wherein the payment product includes a token for use within the mobile wallet application identifying the virtual payment product for use within the defined geo-fence.

12. The method of claim 9, further comprising sending a denial message to the merchant POS device for declining the transaction request when the participant computing device is determined to be located outside the defined geo-fence.

13. The method of claim 9, further comprising:
reading account and location information from the payment product; and
generating the transaction request based on the account and location information and a monetary amount of the purchase.

14. The method of claim 9, further comprising encrypting the transaction request.

15. The method of claim 9, wherein determining if the participant computing device is located within the defined geo-fence based on the received transaction request comprises extracting the coordinate information from the transaction request and comparing the coordinate information to the defined geo-fence.

16. The method of claim 9, wherein defining the geo-fence comprises defining the geo-fence based on at least one of the following technologies: global positioning system (GPS), radio frequency identification (RFID), near field communication (NFC), Bluetooth, Wi-Fi, and geomagnetic.

17. A system comprising:
a program manager server communicatively coupled to a communication network, the program manager server including a memory device storing instructions that, when executed by the program manager server, configure the program manager server to:
define a geo-fence,
create a payment product valid within the defined geo-fence, and
send the payment product to a participant for use within the defined geo-fence;
a merchant point-of-sale (POS) device, the merchant POS device communicatively coupled to the communication network, the merchant POS device including a memory device storing instructions that, when executed by the merchant POS device, configure the merchant POS device to:
read account and location information from the payment product when presented to the merchant POS device to transact a purchase, and
generate a transaction request based on the account and location information and a monetary amount of the purchase; and
a payment processing server communicatively coupled to the communication network, the payment processing server including a memory device storing instructions that, when executed by the payment processing server, configure the payment processing server to:
receive the transaction request to transact the purchase using the payment product from the merchant POS device via the communication network,
determine if the purchase is located within the defined geo-fence based on the received transaction request, and
send an authorization message to the merchant POS device via the communication network for approving the transaction request when the purchase is determined to be located within the defined geo-fence.

18. The system of claim 17, wherein the memory device of the program manager server stores instructions that, when executed by the program manager server, further configure the program manager server to send the payment product to a mobile wallet application on a participant computing device as a virtual payment product.

19. The system of claim 17, wherein the memory device of the payment processing server stores instructions that, when executed by the payment processing server, further configure the payment processing server to send a denial message to the merchant POS device via the communication network for declining the transaction request when the purchase is determined to be located outside the defined geo-fence.

20. The system of claim 17, wherein the memory device of the merchant POS device stores instructions that, when executed by the merchant POS device, configure the merchant POS device to encrypt the transaction request before sending the transaction request to the payment processing server.
